(19) United States
(12) Patent Application Publication
(10) Pub. No.: US 2024/0079177 A1
(43) Pub. Date: Mar. 7, 2024

(54) MULTILAYER COIL COMPONENT

(71) Applicant: TDK CORPORATION, Tokyo (JP)

(72) Inventors: Yusuke NAGAI, Tokyo (JP); Kazuhiro EBINA, Tokyo (JP); Takahiro SATO, Tokyo (JP); Masaki TAKAHASHI, Tokyo (JP); Takashi ENDO, Tokyo (JP); Yuya ISHIMA, Tokyo (JP); Kosuke ITO, Tokyo (JP); Takuya MIYASHITA, Tokyo (JP)

(73) Assignee: TDK CORPORATION, Tokyo (JP)

(21) Appl. No.: 18/359,419

(22) Filed: Jul. 26, 2023

(30) Foreign Application Priority Data
Sep. 7, 2022 (JP) 2022-142207

(51) Int. Cl. H01F 27/29; H01F 17/00

(52) U.S. Cl. CPC H01F 27/292; H01F 17/0013; H01F 2017/0066

(57) ABSTRACT

A multilayer coil component includes an element body, a plurality of coil conductors, a first resistive layer, and a second resistive layer. The plurality of coil conductors are disposed in the element body and electrically connected to each other. The plurality of coil conductors include a first coil conductor and a second coil conductor adjacent to each other. The first resistive layer and the second resistive layer oppose each other between the first coil conductor and the second coil conductor. The first resistive layer is in contact with the first coil conductor.

### CROSS-REFERENCE TO RELATED APPLICATIONS

This application is based upon and claims the benefit of priority from Japanese Patent Application No. 2022-142207, filed on Sep. 7, 2022. The entire contents of which are incorporated herein by reference.

### BACKGROUND

### Field

The present disclosure relates to a multilayer coil component.

### Description of the Related Art

Known multilayer coil components include an element body and a plurality of coil conductors in the element body (see, for example, Japanese Unexamined Patent Publication No. 2017-059749). The plurality of coil conductors are arranged in one direction and electrically connected to each other.

### SUMMARY

One aspect of the present disclosure provides a multilayer coil component reducing occurrence of a short circuit between coil conductors adjacent to each other.

A multilayer coil component according to one aspect of the present disclosure includes an element body, a plurality of coil conductors, a first resistive layer, and a second resistive layer. The plurality of coil conductors are disposed in the element body and electrically connected to each other. The plurality of coil conductors include a first coil conductor and a second coil conductor adjacent to each other. The first resistive layer and the second resistive layer oppose each other between the first coil conductor and the second coil conductor. The first resistive layer is in contact with the first coil conductor.

In the one aspect described above, the first resistive layer and the second resistive layer are disposed between the first coil conductor and the second coil conductor. Therefore, the one aspect described above tends to increase insulation resistance between the first coil conductor and the second coil conductor.

In the one aspect described above, the first resistive layer is in contact with the first coil conductor. Therefore, the one aspect described above reliably increases the insulation resistance between the first coil conductor and the second coil conductor.

Consequently, the one aspect described above reduces occurrence of a short circuit between the first coil conductor and the second coil conductor.

In the one aspect described above, the first resistive layer may be along the first coil conductor. The first resistive layer may have a width larger than a width of the first coil conductor.

A configuration in which the width of the first resistive layer along the first coil conductor is larger than the width of the first coil conductor further reliably increases the insulation resistance between the first coil conductor and the second coil conductor. Therefore, this configuration further reduces the occurrence of the short circuit between the first coil conductor and the second coil conductor.

In the one aspect described above, the second resistive layer may be along the first coil conductor. The second resistive layer may have a width larger than a width of the first coil conductor.

A configuration in which the width of second resistive layer along the first coil conductor is larger than the width of the first coil conductor further reliably increases the insulation resistance between the first coil conductor and the second coil conductor. Therefore, this configuration further reduces the occurrence of the short circuit between the first coil conductor and the second coil conductor.

The one aspect described above may include a stress relaxation layer between the first resistive layer and the second resistive layer. The stress relaxation layer may include at least one of a resin or a gap.

The stress relaxation layer relaxes internal stress in the element body. A configuration including the stress relaxation layer reduces occurrence of a crack between the first coil conductor and the second coil conductor. Therefore, this configuration reduces occurrence of a short circuit due to the crack between the first coil conductor and the second coil conductor.

In the one aspect described above, the element body may include a portion located between the second resistive layer and the second coil conductor.

A configuration in which the element body includes the portion tends to increase the insulation resistance between the first coil conductor and the second coil conductor. Therefore, this configuration further reduces the occurrence of the short circuit between the first coil conductor and the second coil conductor.

In the one aspect described above, the first resistive layer and the second resistive layer may include zirconia.

### BRIEF DESCRIPTION OF THE DRAWINGS

FIG. 1 is a perspective view illustrating a multilayer coil component according to an example;

FIG. 2 is an exploded perspective view illustrating the multilayer coil component according to the present example;

FIG. 3 is a plan view illustrating a coil conductor;

FIG. 4 is a plan view illustrating a coil conductor;

FIG. 5 is a plan view illustrating a coil conductor;

FIG. 6 is a view illustrating a cross-sectional configuration of the multilayer coil component according to the present example;

FIG. 7 is a view illustrating a cross-sectional configuration of the multilayer coil component according to the present example;

FIG. 8 is a view illustrating a cross-sectional configuration of the multilayer coil component according to a modified example of the present example; and

FIG. 9 is a view illustrating a cross-sectional configuration of the multilayer coil component according to another modified example of the present example.

### DETAILED DESCRIPTION

In the following description, with reference to the drawings, the same reference numbers are assigned to the same components or to similar components having the same function, and overlapping description is omitted.

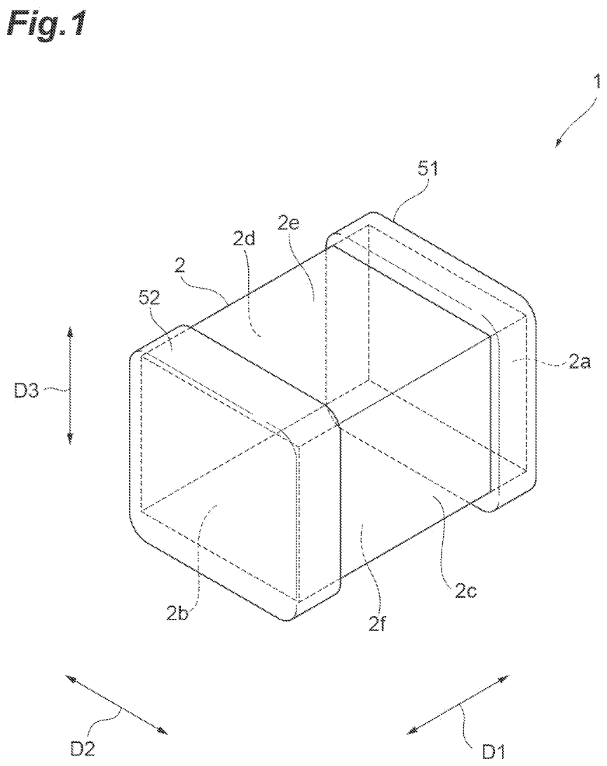

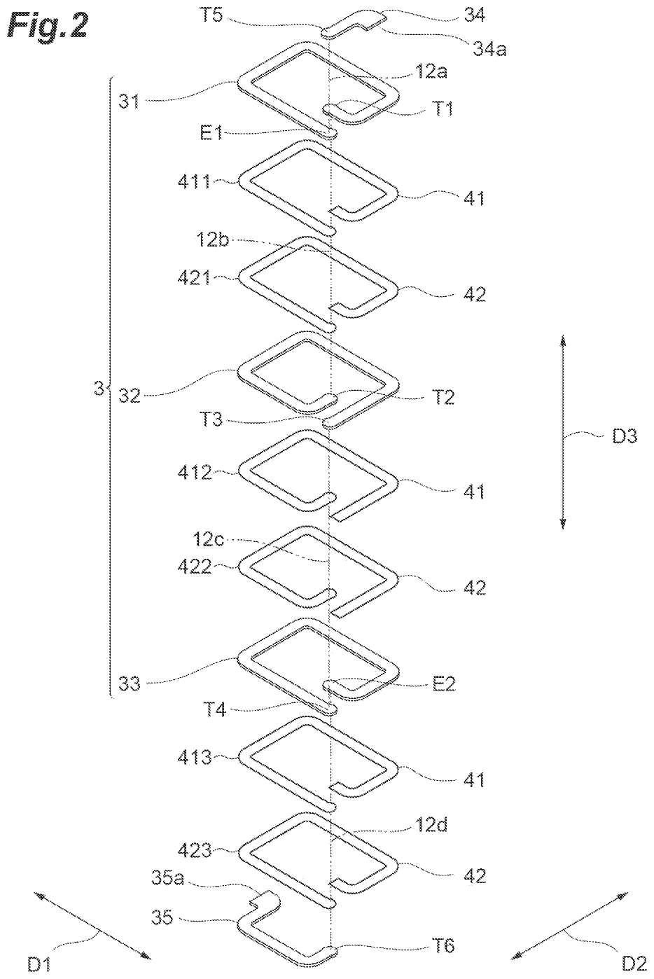

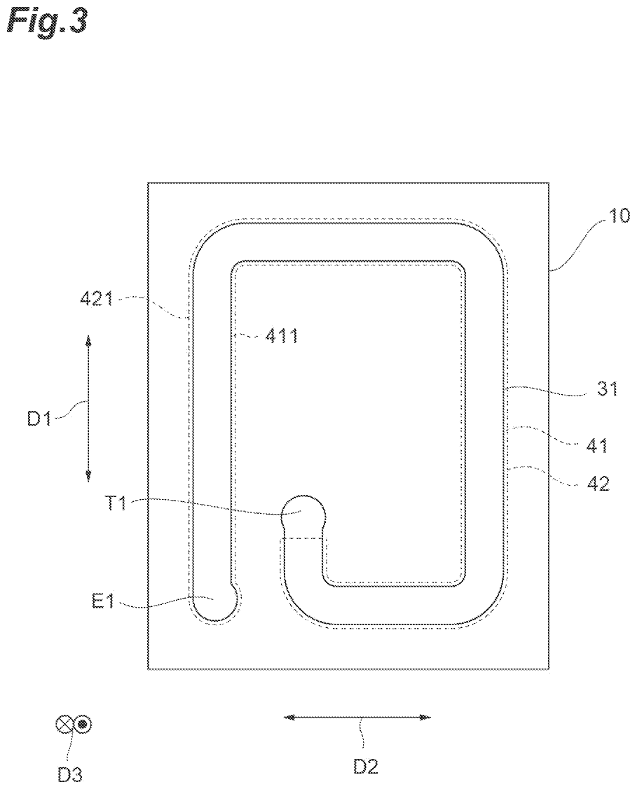

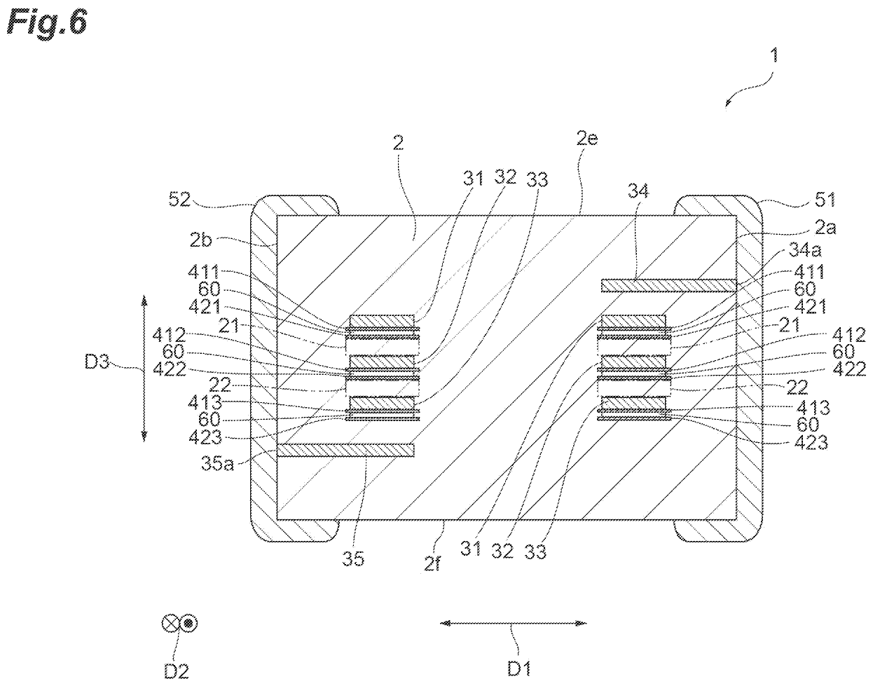

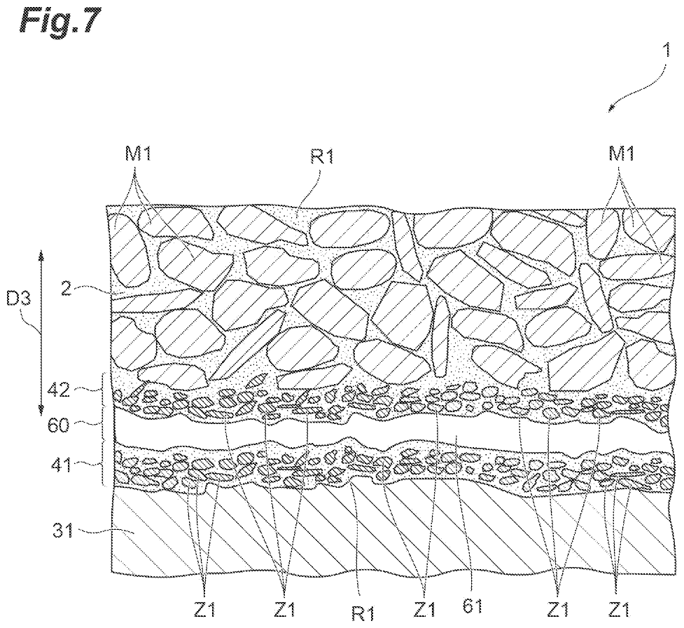

A configuration of the multilayer coil component 1 according to the present example will be described with reference to FIG. 1 to FIG. 7. FIG. 1 is a perspective view illustrating a multilayer coil component according to the present example. FIG. 2 is an exploded perspective view illustrating the multilayer coil component according to the present example. FIG. 3 to FIG. 5 are plan views illustrating a coil conductor. FIG. 6 and FIG. 7 are views illustrating a cross-sectional configuration of the multilayer coil component according to the present example. The multilayer coil component 1 is solder-mounted on an electronic device, for example. The electronic device includes, for example, a circuit board or an electronic component.

As illustrated in FIG. 1 and FIG. 2, the multilayer coil component 1 includes an element body 2, a coil 3, a pair of connection conductors 34 and 35, at least one resistive layer 41, at least one resistive layer 42, and a pair of external electrodes 51 and 52. The coil 3 includes a plurality of coil conductors 31, 32, and 33. In the present example, the coil 3 includes three coil conductors 31, 32, and 33. For example, when the resistive layer 41 includes a first resistive layer, the resistive layer 42 includes a second resistive layer. In the present example, the number of each of the resistive layers 41 and 42 is “3”. For example, one resistive layer 41 and one resistive layer 42 constitute one set. In the present example, the multilayer coil component 1 includes three sets of resistive layers 41 and 42. The number of the coil conductors 31, 32, and 33 is not limited to the above-described number. The number of the coil conductors 31, 32, and 33 may be larger or smaller than the above-described number. The number of the resistive layers 41 and 42 is not limited to the above-described number. The number of the resistive layers 41 and 42 may be larger or smaller than the above-described number.

As illustrated in FIG. 1, the element body 2 has a rectangular parallelepiped shape. The rectangular parallelepiped shape includes, for example, a rectangular parallelepiped shape in which corner portions and ridge portions are chamfered or a rectangular parallelepiped shape in which corner portions and ridge portions are rounded. The element body 2 includes a pair of end surfaces 2a and 2b opposing each other, and four side surfaces 2c, 2d, 2e, and 2f. In the present example, the pair of end surfaces 2a and 2b oppose each other in a direction D1, the side surfaces 2c and 2d oppose each other in a direction D2, and the side surfaces 2e and 2f oppose each other in a direction D3. An outer surface of the element body 2 includes the pair of end surfaces 2a and 2b and the four side surfaces 2c, 2d, 2e, and 2f. Each of the four side surfaces 2c, 2d, 2e, and 2f is adjacent to the end surfaces 2a and 2b, and couples the end surface 2a and the end surface 2b along the direction D1. In the multilayer coil component 1 mounted on the electronic device (not illustrated), for example, one of the four side surfaces 2c, 2d, 2e, and 2f opposes the electronic device. The one of the four side surfaces 2c, 2d, 2e, and 2f is arranged to constitute a mounting surface.

For example, the direction D1 is orthogonal to the pair of end surfaces 2a and 2b. For example, the direction D2 is orthogonal to the side surfaces 2c and 2d. For example, the direction D3 is orthogonal to the side surfaces 2e and 2f. For example, the direction D1 is orthogonal to the directions D2 and D3. For example, the direction D2 is orthogonal to the direction D3.

The element body 2 includes a plurality of magnetic layers 10. As illustrated in FIG. 3 to FIG. 5, the element body 2 is formed through laminating the plurality of magnetic layers 10. The magnetic layers 10 are arranged in the direction D3. Each magnetic layer 10 has a rectangular shape in a plan view in the direction D3. The rectangular shape includes, for example, a rectangular shape in which corners are rounded or a rectangular shape in which corners are chamfered. The plurality of magnetic layers 10 are integrated to such an extent that the boundaries between the magnetic layers 10 cannot be visually recognized. In FIG. 2, illustration of each magnetic layer 10 is omitted.

As illustrated in FIG. 2 to FIG. 6, the coil 3 is formed through stacking the plurality of coil conductors 31, 32, and 33. The plurality of coil conductors 31, 32, and 33 are disposed in the element body 2. The plurality of coil conductors 31, 32, and 33 are arranged in the direction D3. The coil conductors 31 and 32 are adjacent to each other and oppose to each other. The coil conductors 32 and 33 are adjacent to each other and oppose to each other. Each of the coil conductors 31, 32, and 33 includes a part of an annular path in the coil 3. Each of the coil conductors 31, 32, and 33 has, for example, a shape in which a part of a loop is interrupted. Each of the coil conductors 31, 32, and 33 includes a pair of ends and has a shape substantially along the annular path from the one end to the other end. For example, when the coil conductor 31 includes a first coil conductor, the coil conductor 32 includes a second coil conductor. For example, when the coil conductor 32 includes a first coil conductor, the coil conductor 33 includes a second coil conductor.

The plurality of coil conductors 31, 32, and 33 are electrically connected to each other. As illustrated in FIG. 2, in the present example, the coil conductors 31 and 32 are electrically connected via the through-hole conductor 12b, and the coil conductors 32 and 33 are electrically connected via the through-hole conductor 12c. The coil conductor 31 includes an end T1, and the coil conductor 32 includes a pair of ends T2 and T3. The through-hole conductor 12b electrically connects the end T1 and the end T2. The coil conductor 33 includes an end T4. The through-hole conductor 12b electrically connects the end T3 and the end T4. Corresponding ends of the ends T1, T2, T3, and T4 are physically and electrically connected to each other via a corresponding through-hole conductor of the through-hole conductors 12b and 12c, so that the plurality of coil conductors 31, 32, and 33 forms the coil 3 in the element body 2.

The coil conductor 31 is closest to the side surface 2e in the direction D3 among the coil conductors 31, 32, and 33. The coil conductor 31 includes the end T1 and another end opposite to the end T1. The other end of coil conductor 31 includes an end E1 of the coil 3. The coil conductor 33 is closest to the side surface 2f in the direction D3 among the coil conductors 31, 32, and 33. The coil conductor 33 includes the end T4 and another end opposite to the end T4. The other end of coil conductor 33 includes an end E2 of the coil 3. The coil 3 includes the pair of ends E1 and E2.

As illustrated in FIG. 6, the connection conductor 34 is closer to the side surface 2e in the direction D3 than the coil conductor 31. The connection conductor 34 and the coil conductor 31 are adjacent to each other in the direction D3. The connection conductor 34 includes a pair of ends T5 and 34a. The end T5 is located in the element body 2. The end T5 of the connection conductor 34 and the other end of the coil conductor 31 (the end E1 of the coil 3) are electrically connected to each other via the through-hole conductor 12a. The end 34a of the connection conductor 34 is exposed to the end surface 2a.

The connection conductor 35 is closer to the side surface 2f in the direction D3 than the coil conductor 33. The connection conductor 35 and the coil conductor 33 are adjacent to each other in the direction D3. The connection conductor 35 includes a pair of ends T6 and 35a. The end T6 is located in the element body 2. The end T6 of the connection conductor 35 and the other end of the coil conductor 33 (the end E2 of the coil 3) are electrically connected to each other via the through-hole conductor 12d. The end 35a of the connection conductor 35 is exposed to the end surface 2b.

As illustrated in FIGS. 1 and 6, the pair of external electrodes 51 and 52 are disposed at both ends of the element body 2 in the direction D1. The pair of external electrodes 51 and 52 are disposed on the element body 2 to oppose each other in the direction D1. The pair of external electrodes 51 and 52 are separated from each other in the direction D1.

The external electrode 51 includes a portion on the end surface 2a covering the end 34a exposed at the end surface 2a. The end 34a and the external electrode 51 are electrically connected to each other. The end 34a electrically connects the connection conductor 34 and the external electrode 51. The coil 3 is electrically connected to the external electrode 51.

The external electrode 52 includes a portion on the end surface 2b covering the end 35a exposed at the end surface 2b. The end 35a and the external electrode 52 are electrically connected to each other. The end 35a electrically connects the connection conductor 35 and the external electrode 52. The coil 3 is electrically connected to the external electrode 52.

The resistive layers 41 and 42 are disposed between adjacent coil conductors of the plurality of coil conductors 31, 32, and 33 to oppose each other. That is, the resistive layer 42 includes a portion away from the resistive layer 41. The resistive layers 41 and 42 oppose each other in the direction D3. In the present example, a first set of resistive layers 41 and 42 is disposed between the coil conductors 31 and 32 adjacent to each other. Hereinafter, the first set of resistive layers 41 and 42 disposed between the coil conductors 31 and 32 may be referred to as resistive layers 411 and 421. The resistive layers 411 and 421 are disposed between the coil conductors 31 and 32 to oppose each other. The resistive layer 411 is in contact with the coil conductor 31. That is, the resistive layer 411 is in contact with a surface of the coil conductor 31 facing the coil conductor 32. The coil conductor 31 includes the surface facing the coil conductor 32 and a surface opposing the surface facing the coil conductor 32. The element body 2 includes a portion 21 between the resistive layer 411 and the coil conductor 32. A thickness of the portion 21 is larger than a thickness of the resistive layer 421. Each of the thicknesses of the portion 21 and the resistive layer 421 is, for example, the thickness in the direction D3. Each of the thicknesses of the portion 21 and the resistive layer 421 in the direction D3 is defined by, for example, the minimum thickness in the direction D3. For example, the thickness of the portion 21 may be larger than a thickness of the resistive layer 411.

In the present example, a second set of resistive layers 41 and 42 is disposed between the coil conductors 32 and 33 adjacent to each other. Hereinafter, the second set of resistive layers 41 and 42 disposed between the coil conductors 32 and 33 may be referred to as resistive layers 412 and 422. The resistive layers 412 and 422 are disposed between the coil conductors 32 and 33 to oppose each other. The resistive layer 412 is in contact with the coil conductor 32. That is, the resistive layer 412 is in contact with a surface of the coil conductor 32 facing the coil conductor 33. The coil conductor 32 includes the surface facing the coil conductor 33 and a surface opposing the surface facing the coil conductor 33. The element body 2 includes a portion 22 between the resistive layer 412 and the coil conductor 33. A thickness of the portion 22 is larger than a thickness of the resistive layer 422. Each of the thicknesses of the portion 22 and the resistive layer 422 is, for example, the thickness in the direction D3. Each of the thicknesses of the portion 22 and the resistive layer 422 in the direction D3 is defined by, for example, the minimum thickness in the direction D3. For example, the thickness of the portion 22 may be larger than a thickness of the resistive layer 412.

A third set of resistive layers 41 and 42 may be disposed between a coil conductor and a connection conductor adjacent to each other. For example, the resistive layers 41 and 42 may be disposed between the coil conductor 33 and the connection conductor 35 adjacent to each other. Hereinafter, the third set of resistive layers 41 and 42 disposed between the coil conductor 33 and the connection conductor 35 may be referred to as resistive layers 413 and 423. The resistive layers 413 and 423 are disposed between the coil conductor 33 and the connection conductor 35 to oppose each other. The resistive layer 413 is in contact with the coil conductor 33. That is, the resistive layer 413 is in contact with a surface of the coil conductor 33 facing the side surface 2f (connection conductor 35). The coil conductor 33 includes the surface facing the side surface 2f and a surface opposing the surface facing the side surface 2f. The element body 2 includes a portion between the resistive layer 423 and the connection conductor 35. A thickness of the portion between the resistive layer 423 and the connection conductor 35 is larger than a thickness of the resistive layer 423. Each of the thicknesses of the portion between the resistive layer 423 and the connection conductor 35 and the resistive layer 423 is, for example, the thickness in the direction D3. Each of the thicknesses of the portion between the resistive layer 423 and the connection conductor 35 and the resistive layer 423 in the direction D3 is defined by, for example, the minimum thickness in the direction D3. For example, the thickness of the portion between the resistive layer 423 and the connection conductor 35 may be larger than a thickness of the resistive layer 413.

As illustrated in FIG. 3, at least one of the resistive layers 411 or 421 is along at least a part of the coil conductor 31. When viewed from the direction D3, the at least one of the resistive layers 411 or 421 extends to include a part of the annular path similarly to the coil conductor 31. When viewed from the direction D3, a width of the at least one of the resistive layers 411 or 421 is larger than a width of the coil conductor 31. When viewed from the direction D3, the at least one of the resistive layers 411 or 421 covers substantially the entire coil conductor 31. In the present example, each of the resistive layers 411 and 421 is entirely along the coil conductor 31 except for the end T1. When viewed from the direction D3, each of the resistive layers 411 and 421 extends to include a part of the annular path similarly to the coil conductor 31. When viewed from the direction D3, each width of the resistive layers 411 and 421 is larger than the width of the coil conductor 31. When viewed from the direction D3, each of the resistive layers 411 and 421 covers substantially the entire the coil conductor 31. That is, each of the resistive layers 411 and 421 covers the surface of the coil conductor 31 facing the coil conductor 32. For example, the resistive layer 411 directly covers the surface of the coil conductor 31 facing the coil conductor 32, and the resistive layer 421 indirectly covers the surface of the coil conductor 31 facing the coil conductor 32.

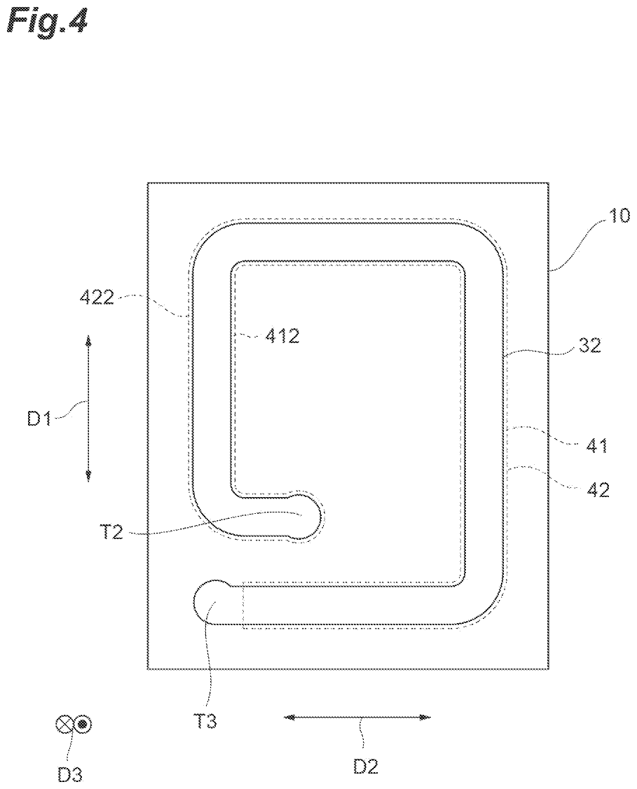

As illustrated in FIG. 4, at least one of the resistive layers 412 or 422 is along at least a part of the coil conductor 32. When viewed from the direction D3, the at least one of the resistive layers 412 or 422 extends to include a part of the annular path similarly to the coil conductor 32. When viewed from the direction D3, a width of the at least one of the resistive layers 412 or 422 is larger than a width of the coil conductor 32. When viewed from the direction D3, the at least one of the resistive layers 412 or 422 covers substantially the entire coil conductor 32. In the present example, each of the resistive layers 412 and 422 is entirely along the coil conductor 32 except for the end T3. When viewed from the direction D3, each of the resistive layers 412 and 422 extends to include a part of the annular path similarly to the coil conductor 32. When viewed from the direction D3, each width of the resistive layers 412 and 422 is larger than the width of the coil conductor 32. When viewed from the direction D3, each of the resistive layers 412 and 422 covers substantially the entire the coil conductor 32. That is, each of the resistive layers 412 and 422 covers the surface of the coil conductor 32 facing the coil conductor 33. For example, the resistive layer 412 directly covers the surface of the coil conductor 32 facing the coil conductor 33, and the resistive layer 422 indirectly covers the surface of the coil conductor 32 facing the coil conductor 33.

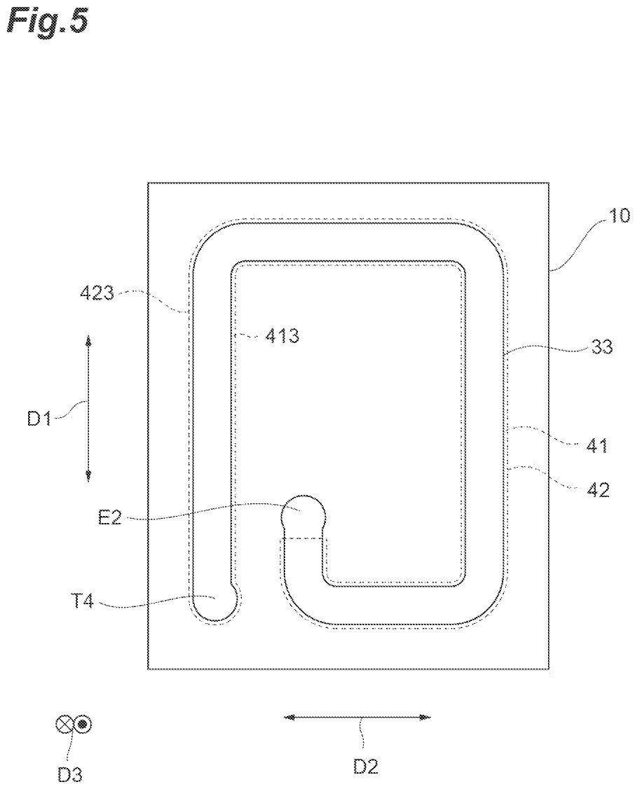

As illustrated in FIG. 5, at least one of the resistive layers 413 or 423 may be along at least a part of the coil conductor 33. When viewed from the direction D3, the at least one of the resistive layers 413 or 423 may extend to include a part of the annular path similarly to the coil conductor 33. When viewed from the direction D3, a width of the at least one of the resistive layers 413 or 423 may be larger than a width of the coil conductor 33. When viewed from the direction D3, the at least one of the resistive layers 413 or 423 may cover substantially the entire coil conductor 33. In the present example, each of the resistive layers 413 and 423 is entirely along the coil conductor 33 except for the other end including the end E2. When viewed from the direction D3, each of the resistive layers 413 and 423 extends to include a part of the annular path similarly to the coil conductor 33. When viewed from the direction D3, each width of the resistive layers 413 and 423 is larger than the width of the coil conductor 33. When viewed from the direction D3, each of the resistive layers 413 and 423 covers substantially the entire the coil conductor 33. That is, each of the resistive layers 413 and 423 covers the surface of the coil conductor 33 facing the side surface 2f (connection conductor 35). For example, the resistive layer 413 directly covers the surface of the coil conductor 33 facing the side surface 2f, and the resistive layer 423 indirectly covers the surface of the coil conductor 33 facing the side surface 2f.

As illustrated in FIGS. 6 and 7, the multilayer coil component 1 includes a stress relaxation layer 60. In the present example, the multilayer coil component 1 includes a plurality of stress relaxation layers 60. The stress relaxation layer 60 is disposed between the resistive layer 41 and the resistive layer 42. The stress relaxation layers 60 are disposed between the resistive layers 411 and 421, between the resistive layers 412 and 422, and between the resistive layers 413 and 423. In the present example, the stress relaxation layer 60 is along at least a part of each of the resistive layers 41 and 42. The stress relaxation layer 60 is along at least a part of each of the coil conductors 31, 32, and 33.

A thickness of the stress relaxation layer 60 may be larger than a thickness of at least one of the resistive layer 41 or the resistive layer 42. Each of the thicknesses of the stress relaxation layer 60 and the at least one of the resistive layer 41 or the resistive layer 42 is, for example, the thickness in the direction D3. In the present example, the thickness of the stress relaxation layer 60 is larger than the thicknesses of the resistive layers 41 and 42. The thickness of the stress relaxation layer 60 is smaller than the thicknesses of the portions 21 and 22. The thickness of the stress relaxation layer 60 is, for example, 1.0 μm or more and 10 μm or less. The thicknesses of the resistive layers 41 and 42 is, for example, 0.1 μm or more and 5.0 μm or less. In the present example, the stress relaxation layer 60 includes a gap 61.

Each of the thicknesses of the stress relaxation layer 60 and the resistive layers 41 and 42 is defined by, for example, the minimum thickness. The thicknesses of the stress relaxation layer 60 and the resistive layers 41 and 42 may be measured, for example, at a position where the thicknesses of the resistive layers 41 and 42 is minimum. The thicknesses of the stress relaxation layer 60 and the resistive layers 41 and 42 may be measured, for example, at a position where the thickness of the stress relaxation layer 60 is maximum.

When viewed from the direction D3, the width of the stress relaxation layer 60 may be equal to or smaller than the widths of the resistive layers 41 and 42 or may be equal to or larger than the width of the resistive layers 41 and 42. In the present example, when viewed from the direction D3, the width of the stress relaxation layer 60 is smaller than the widths of the resistive layers 41 and 42. The width of the stress relaxation layer 60 may be at least larger than the thickness of the stress relaxation layer 60.

Next, configurations of the element body 2, the coil conductor 31, and the resistive layers 41 and 42 will be described with reference to FIG. 7. The element body 2 includes a plurality of metal magnetic particles M1. The plurality of metal magnetic particles M1 include, for example, a soft magnetic alloy. The soft magnetic alloy includes, for example, a Fe—Si-based alloy. When the soft magnetic alloy includes the Fe—Si-based alloy, the soft magnetic alloy may include P. The soft magnetic alloy may include, for example, a Fe—Ni—Si-M-based alloy. “M” includes one or more elements selected from the group consisting of Co, Cr, Mn, P, Ti, Zr, Hf, Nb, Ta, Mo, Mg, Ca, Sr, Ba, Zn, B, Al, and rare-earth elements.

Each metal magnetic particle M1 is formed with an oxide film on a surface thereof. Each metal magnetic particle M1 may include the oxide film on the surface thereof. The plurality of metal magnetic particles M1 adjacent to each other are bonded to each other through bonding the oxide films formed on the surfaces of the plurality of metal magnetic particles M1 adjacent to each other. The adjacent metal magnetic particles M1 are bonded to each other with the oxide film that is present between the adjacent metal magnetic particles M1. In FIG. 7, the oxide films are not illustrated. A resistance value of the metal magnetic particle M1 including the oxide film may be, for example, not less than 10⁹ (Q·cm) and not more than 10¹¹ (Q·cm).

The element body 2 includes a resin R1. The resin R1 has electrical insulation. The resin R1 is present between the plurality of metal magnetic particles M1. The resin R1 includes an electrically insulating resin. The electrically insulating resin includes, for example, silicone resin, phenolic resin, acrylic resin, or epoxy resin. The resin R1 may be impregnated into the gaps between the plurality of metal magnetic particles M1 adjacent to each other. A resistance value of the resin R1 may be, for example, not less than 10¹² (Q·cm) and not more than 10¹⁷ (Q·cm).

Each of the coil conductors 31, 32, and 33 includes an electrically conductive material. This electrically conductive material may include, for example, Ag, Pd, Cu, Al, or Ni. In the present example, the coil conductors 31, 32, and 33 include a sintered body of a conductive paste containing electrically conductive material powders. Each of the through-hole conductors 12a, 12b, 12c, and 12d includes an electrically conductive material. The through-hole conductors 12a, 12b, 12c, and 12d may include, for example, the same material as the coil conductors 31, 32, and 33. Each of the connection conductors 34 and 35 includes an electrically conductive material. The connection conductors 34 and 35 may include, for example, the same material as the coil conductors 31, 32, and 33. The coil conductors 31, 32, and 33, the through-hole conductors 12a, 12b, 12c, and 12d, and the connection conductors 34 and 35 may include a plated conductor.

Each of the resistive layers 41 and 42 includes a material different from that of the element body 2. Each of the resistive layers 41 and 42 may include a material having a resistance value larger than the resistance value of each magnetic metal particle M1 including the oxide film. The resistive layers 41 and 42 may include an insulating material. In the present example, the resistive layers 41 and 42 include zirconia (ZrO₂). The resistive layers 41 and 42 include, for example, zirconia particles Z1. In the present example, the resistive layers 41 and 42 are formed through firing a paste including zirconia powder, an organic solvent, and an organic binder. An average particle diameter of the zirconia particles Z1 may be 0.1 μm or less. A resistance value of each of the resistive layers 41 and 42 may be, for example, not less than 10¹² (Q·cm) and not more than 10¹⁴ (Q·cm).

As described above, in the multilayer coil component 1, the resistive layers 411 and 421 is disposed between the coil conductors 31 and 32 adjacent to each other. Therefore, the multilayer coil component 1 tends to increase insulation resistance between the coil conductors 31 and 32. In the multilayer coil component 1, the resistive layers 412 and 422 is disposed between the coil conductors 32 and 33 adjacent to each other. Therefore, the multilayer coil component 1 tends to increase insulation resistance between the coil conductors 32 and 33.

In the multilayer coil component 1, the resistive layer 411 is in contact with the coil conductor 31. Therefore, the multilayer coil component 1 reliably increases the insulation resistance between the coil conductors 31 and 32. In the multilayer coil component 1, the resistive layer 412 is in contact with the coil conductor 32. Therefore, the multilayer coil component 1 reliably increases the insulation resistance between the coil conductors 32 and 33.

Consequently, the multilayer coil component 1 reduces occurrence of a short circuit between the coil conductors 31, 32, and 33.

In the multilayer coil component 1, the resistive layer 411 is along the coil conductor 31. The resistive layer 412 is along the coil conductor 32. The resistive layer 411 has the width larger than the width of the coil conductor 31. The resistive layer 412 has the width larger than the width of the coil conductor 32.

The multilayer coil component 1 in which the width of the resistive layer 411 along the coil conductor 31 is larger than the width of the coil conductor 31 further reliably increases the insulation resistance between the coil conductor 31 and 32. The multilayer coil component 1 in which the width of the resistive layer 412 along the coil conductor 32 is larger than the width of the coil conductor 32 further reliably increases the insulation resistance between the coil conductor 32 and 33. Therefore, the multilayer coil component 1 further reduces the occurrence of the short circuit between the coil conductors 31, 32, and 33.

In the multilayer coil component 1, the resistive layer 421 is along the coil conductor 31. The resistive layer 422 is along the coil conductor 32. The resistive layer 421 has the width larger than the width of the coil conductor 31. The resistive layer 422 has the width larger than the width of the coil conductor 32.

The multilayer coil component 1 in which the width of the resistive layer 421 along the coil conductor 31 is larger than the width of the coil conductor 31 further reliably increases the insulation resistance between the coil conductor 31 and 32. The multilayer coil component 1 in which the width of the resistive layer 422 along the coil conductor 32 is larger than the width of the coil conductor 32 further reliably increases the insulation resistance between the coil conductor 32 and 33. Therefore, the multilayer coil component 1 further reduces the occurrence of the short circuit between the coil conductors 31, 32, and 33.

The multilayer coil component 1 includes the stress relaxation layer 60 between the resistive layers 41 and 42. The stress relaxation layer 60 includes the gap 61.

The stress relaxation layer 60 relaxes internal stress in the element body 2. The multilayer coil component 1 including the stress relaxation layer 60 reduces occurrence of a crack between the coil conductors 31, 32, and 33. Therefore, the multilayer coil component 1 reduces occurrence of a short circuit due to the crack between the coil conductors 31, 32, and 33.

The internal stress in the element body 2 is generated, for example, due to a difference in the amount of contraction between the plurality of coil conductors 31, 32, and 33 and other portions of the multilayer coil component 1 in the firing process of the multilayer coil component 1. The stress relaxation layer 60 including the gap 61 can absorb internal stress-induced deformation. The stress relaxation layer 60 relaxes the internal stress in the element body 2. Therefore, the multilayer coil component 1 reduces the occurrence of the crack between the coil conductors 31, 32, and 33.

The resistive layer 41 and the resistive layer 42 oppose each other with the stress relaxation layer 60 interposed between the resistive layers 41 and 42. For example, even if a crack occurs in the resistive layer 41 due to a difference in the amount of contraction between each coil conductors 31, 32, and 33 and the resistive layer 41, the crack tends not to progress to the resistive layer 42 because the stress relaxation layer 60 is interposed between the resistive layer 41 and the resistive layer 42. Even if the crack occurs, the crack tends not to spread between the coil conductors 31, 32, and 33. Therefore, the multilayer coil component 1 reliably reduces the occurrence of the short circuit due to the crack between the coil conductors 31, 32, and 33.

In the multilayer coil component 1, the element body 2 includes the portion 21 between the resistive layer 421 and the other coil conductor 32. The element body 2 includes the portion 22 between the resistive layer 422 and the other coil conductor 33.

The multilayer coil component 1 in which the element body 2 includes the portion 21 tends to increase the insulation resistance between the coil conductors 31 and 32. The multilayer coil component 1 in which the element body 2 includes the portion 22 tends to increase the insulation resistance between the coil conductors 32 and 33. Therefore, the multilayer coil component 1 further reduces the occurrence of the short circuit between the coil conductors 31, 32, and 33.

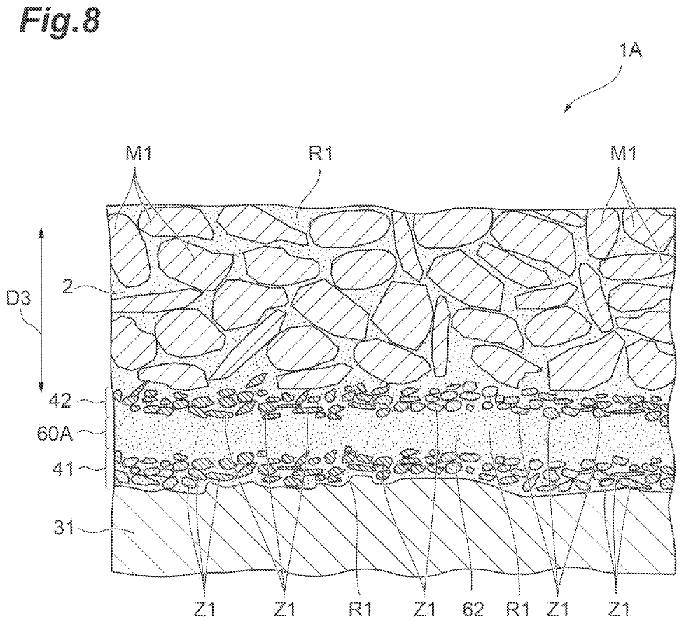

Next, a configuration of a multilayer coil component 1A according to a modified example of the present example will be described with reference to FIG. 8. FIG. 8 is a view illustrating a cross-sectional configuration of the multilayer coil component according to the modified example of the present example. The multilayer coil component 1A is generally similar or identical to the multilayer coil component 1 described above. However, the multilayer coil component 1A differs from the multilayer coil component 1 in the configuration of the stress relaxation layer. The difference between the multilayer coil component 1A and the multilayer coil component 1 will be mainly described below.

The multilayer coil component 1A includes a stress relaxation layer 60A instead of the stress relaxation layer 60. The stress relaxation layer 60A includes a resin 62. The resin 62 includes, for example, the resin R1. The resin R1 may be impregnated not only into the gaps between the plurality of metal magnetic particles M1 adjacent to each other but also into the gap 61. The stress relaxation layer 60A has lower rigidity than other portions of the multilayer coil component 1A.

The multilayer coil component 1A includes the stress relaxation layer 60A between the resistive layer 41 and the resistive layer 42. The stress relaxation layer 60A includes the resin R1.

The stress relaxation layer 60A including the resin R1 has lower rigidity than other portions of the multilayer coil component 1A. The stress relaxation layer 60A including the resin R1 tends to deform. Deformation of the stress relaxation layer 60A can reduce strain in the element body 2 due to the internal stresses. Therefore, the multilayer coil component 1A reduces occurrence of the crack between the coil conductors 31, 32, and 33.

In the multilayer coil component 1A, the stress relaxation layer 60A including the resin R1 is disposed between the resistive layer 41 and the resistive layer 42. The resin R1 included in the stress relaxation layer 60A between the resistive layers 411 and 421 fixes the resistive layer 411 in contact with the coil conductor 31 to the coil conductor 31. The resin R1 included in the stress relaxation layer 60A between the resistive layers 412 and 422 fixes the resistive layer 412 in contact with the coil conductor 32 to the coil conductor 32. Therefore, for example, even when the coil conductors 31 and 32 repeat expansion and contraction due to temperature change caused by energizing the multilayer coil component 1A, the resistive layer 411 tends not to be separated from the coil conductor 31 and the resistive layers 412 tends not to be separated from the coil conductor 32.

Consequently, the multilayer coil component 1A tends not to deteriorate the insulation resistance between the plurality of coil conductors 31, 32, and 33. The multilayer coil component 1A further reduces the occurrence of the short circuit between the coil conductors 31, 32, and 33.

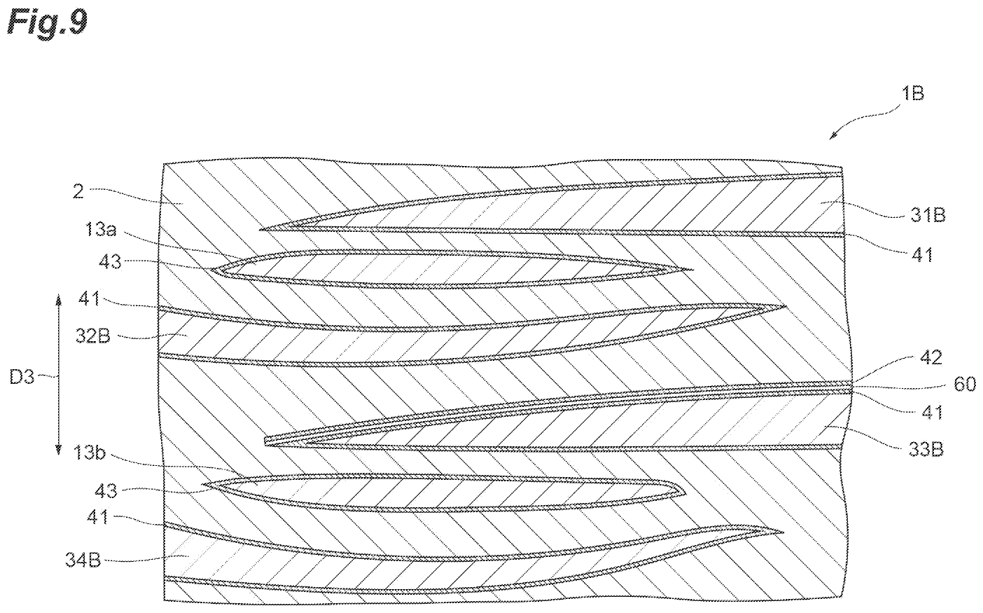

Next, a configuration of a multilayer coil component 1B according to another modified example of the present example will be described with reference to FIG. 9. FIG. 9 is a view illustrating a cross-sectional configuration of the multilayer coil component according to the other modified example of the present example. The multilayer coil component 1B is generally similar or identical to the multilayer coil component 1 described above. However, the multilayer coil component 1B differs from the multilayer coil component 1 in the configuration of the plurality of coil conductors. The difference between the multilayer coil component 1B and the multilayer coil component 1 will be mainly described below.

The multilayer coil component 1B may include a plurality of coil conductors 31B, 32B, 33B, and 34B instead of the plurality of coil conductors 31, 32, and 33. The multilayer coil component 1B may include a plurality of through-hole conductors 13a and 13b instead of the plurality of through-hole conductors 12b and 12c. The multilayer coil component 1B may include a resistive layer 43. Coil conductors adjacent to each other, among the plurality of coil conductors 31B, 32B, 33B, and 34B, may be at least partially adjacent to each other. A through-hole conductor may be interposed between coil conductors adjacent to each other among the plurality of coil conductors 31B, 32B, 33B, and 34B.

For example, the coil conductors 31B and 32B are adjacent to each other. For example, a part of the coil conductor 31B is adjacent to a part of the coil conductor 32B. The through-hole conductor 13a is disposed between the coil conductors 31B and 32B. The through-hole conductor 13a includes, for example, a pad conductor. For example, the coil conductors 32B and 33B are adjacent to each other. For example, a part of the coil conductor 32B is adjacent to a part of the coil conductor 33B. A through-hole conductor (not illustrated) is disposed between the coil conductors 32B and 33B. For example, the coil conductors 33B and 34B are adjacent to each other. For example, a part of the coil conductor 33B is adjacent to a part of the coil conductor 34B. The through-hole conductor 13b is disposed between the coil conductors 33B and 34B. The through-hole conductor 13b includes, for example, a pad conductor.

Each of the resistive layer 41 and the resistive layer 42 may not entirely cover a corresponding coil conductor among the coil conductors adjacent to each other. Each of the resistive layer 41 and the resistive layer 42 may entirely cover the corresponding coil conductor among the coil conductors adjacent to each other. In the multilayer coil component 1B, the resistive layer 42 opposing the resistive layer 41 is disposed only between the coil conductors 32B and 33B adjacent to each other.

The resistive layer 41 may cover a surface of one of the coil conductors adjacent to each other. In the multilayer coil component 1B, the resistive layer 41 covers the respective surfaces of the coil conductors 31B, 32B, 33B, and 34B. The resistive layer 43 covers the respective surfaces of the through-hole conductors 13a and 13b. For example, the resistive layer 41a may cover a surface of the coil conductor 33B facing the coil conductor 32B and a surface of the coil conductor 33B facing the 34B.

It is to be understood that not all aspects, advantages and features described herein may necessarily be achieved by, or included in, any one particular example. Indeed, having described and illustrated various examples herein, it should be apparent that other examples may be modified in arrangement and detail.

The resistive layers 41 and 42 may at least partially oppose each other. The resistive layers 41 and 42 may be partially in contact with each other. For example, the resistive layers 41 and 42 may be in contact with each other at ends of the resistive layers 41 and 42 when viewed from the direction D3.

The stress relaxation layers 60 and 60A may be disposed between any one of the resistive layers 411 and 421, the resistive layers 412 and 422, or the resistive layers 413 and 423. For example, the stress relaxation layer 60 and the 60A may be disposed only between the resistive layers 411 and 421, may be disposed only between the resistive layers 412 and 422, or may be disposed only between the resistive layers 413 and 423.

The stress relaxation layer 60A may include a resin different from the resin R1.

The stress relaxation layer 60 and 60A may include both the resin and the gap. For example, the stress relaxation layers 60 and 60A may include a portion including the resin and a portion including the gap.

What is claimed is:

1. A multilayer coil component comprising:
an element body;
a plurality of coil conductors disposed in the element body and electrically connected to each other, the plurality of coil conductors including a first coil conductor and a second coil conductor adjacent to each other; and
a first resistive layer and a second resistive layer opposing each other between the first coil conductor and the second coil conductor, wherein
the first resistive layer is in contact with the first coil conductor.

2. The multilayer coil component according to claim 1, wherein
the first resistive layer is along the first coil conductor and has a width larger than a width of the first coil conductor.

3. The multilayer coil component according to claim 1, wherein
the second resistive layer is along the first coil conductor and has a width larger than a width of the first coil conductor.

4. The multilayer coil component according to claim 1, further comprising a stress relaxation layer between the first resistive layer and the second resistive layer including at least one of a resin or a gap.

5. The multilayer coil component according to claim 4, wherein
the stress relaxation layer has a thickness larger than a thickness of at least one of the first resistive layer or the second resistive layer.

6. The multilayer coil component according to claim 1, wherein
the element body includes a portion between the second resistive layer and the second coil conductor.

7. The multilayer coil component according to claim 1, wherein
the first resistive layer and the second resistive layer include zirconia.

8. The multilayer coil component according to claim 1, wherein
each of the first resistive layer and the second resistive layer is along the first coil conductor and has a width larger than a width of the first coil conductor.

9. A multilayer coil component comprising:
an element body;
a plurality of coil conductors disposed in the element body and electrically connected to each other, the plurality of coil conductors including a first surface and a second surface opposing each other;
at least one first resistive layer in contact with the first surface included in at least one coil conductor of the plurality of coil conductors; and
at least one second resistive layer including a portion away from the at least one first resistive layer.

10. The multilayer coil component according to claim 9, wherein
the at least one first resistive layer is along the at least one coil conductor and has a width larger than a width of the at least one coil conductor.

11. The multilayer coil component according to claim 9, wherein
the at least one second resistive layer is along the at least one coil conductor and has a width larger than a width of the at least one coil conductor.

12. The multilayer coil component according to claim 9, wherein
the at least one first resistive layer includes a plurality of first resistive layers each in contact with the first surface included in a corresponding coil conductor of the plurality of coil conductors.

13. The multilayer coil component according to claim 12, wherein
the at least one second resistive layer includes a plurality of second resistive layers each including a portion away from a corresponding first resistive layer of the plurality of first resistive layers.

14. The multilayer coil component according to claim 9, further comprising at least one stress relaxation layer between the at least one first resistive layer and the at least one second resistive layer including at least one of a resin or a gap.

15. The multilayer coil component according to claim 14, wherein
the at least one stress relaxation layer has a thickness larger than a thickness of at least one of the at least one first resistive layer or the at least one second resistive layer.

16. The multilayer coil component according to claim 9, wherein
the element body includes a portion between the at least one second resistive layer and a coil conductor, among the plurality of coil conductors, adjacent to the at least one coil conductor.

17. The multilayer coil component according to claim 9, wherein
the at least one first resistive layer and the at least one second resistive layer include zirconia.

18. The multilayer coil component according to claim 9, further comprising a plurality of stress relaxation layers including at least one of a resin or a gap, wherein
the at least one first resistive layer includes a plurality of first resistive layers each in contact with the first surface included in a corresponding coil conductor of the plurality of coil conductors,
the at least one second resistive layer includes a plurality of second resistive layers each including a portion away from a corresponding first resistive layer of the plurality of first resistive layers, and
each of the plurality of stress relaxation layers is between a corresponding first resistive layer of the plurality of first resistive layers and a corresponding second resistive layer of the plurality of second resistive layers.

19. The multilayer coil component according to claim 18, wherein
each of the plurality of stress relaxation layer has a thickness larger than each thickness of the plurality of first resistive layer and the plurality of second resistive layer.
